(19) United States
(12) Patent Application Publication
(10) Pub. No.: US 2025/0138219 A1
(43) Pub. Date: May 1, 2025

(54) DETERMINATION OF 3D MINIMUM HORIZONTAL STRESS FOR NATURALLY FRACTURED RESERVOIRS

(71) Applicant: Saudi Arabian Oil Company, Dhahran (SA)

(72) Inventors: Otto Meza Camargo, Dhahran (SA); Sami AlAwfi, Dammam (SA); Waheed Arshad, Dhahran (SA); Karla Olvera Carranza, Dhahran (SA)

(21) Appl. No.: 18/495,469

(22) Filed: Oct. 26, 2023

(51) Int. Cl. G01V 99/00

(52) U.S. Cl. CPC G01V 20/00

(57) ABSTRACT

Determining three-dimensional (3D) minimum horizontal stress magnitude from mechanical properties, rock strength properties, reservoir pressure, vertical stress, a fracture density index distributed across a 3D geological grid, and formation testing data from formation tests such as a formation integrity test (FIT), a leak off test (LOT), an extended leak off test (XLOT), and a diagnostic fracture injection test. The 3D minimum horizontal stress magnitude may be used to determine sweet spots for hydraulic fracturing operations.

### BACKGROUND

### Field of the Disclosure

The present disclosure generally relates to the extraction of hydrocarbon (for example, oil and gas) resources. More specifically, embodiments of the disclosure relate to the determination of 3D horizontal stresses in hydrocarbon-bearing naturally fractured reservoirs.

### Description of the Related Art

The extraction of hydrocarbon resources from reservoirs in rock formations may depend on a variety of factors. By way of example, minimum horizontal stress is an important parameter for geomechanical characterization that is used in wellbore stability modeling, hydraulic fracturing stimulation, and fluid and solid injection. Some reservoirs, such as naturally fractured reservoirs, may present particular challenges in characterization of the reservoirs. For example, natural fractures can have a negative or positive effect on the minimum horizontal stress magnitude. These effects are typically difficult to quantify using conventional geomechanical techniques, as such techniques are more suitable for intact rock or non-fracture rock types.

### SUMMARY

In reservoir characterization, a three-dimensional (3D) mechanical earth model may be constructed based on geomechanical numerical simulation that uses inputs such as elastic properties and rock strength properties, as well as defined boundary conditions. Results of these simulations may be determined by the calculations of the three principal stress magnitudes such as maximum horizontal stress, minimum horizontal stress, and vertical stress. In order to produce reliable results, especially for the minimum horizontal stress magnitude, several iterations of geomechanical numerical simulation are required to capture observations points such as Formation Integrity Test (FIT), Leak off test (LOT), extended leak off test (XLOT), Fracture Closure Pressure (FCP), or combinations thereof.

Embodiments of the disclosure are directed to the determination of 3D minimum horizontal stress magnitude utilizing mechanical properties, rock strength properties, reservoir pressure, vertical stress, and the fracture density index distributed across the 3D geological grid. Embodiments of the disclosure also include the determination of 3D minimum horizontal stress magnitude from observation points such as Formation Integrity Test (FIT), Leak off test (LOT), extended leak off test (XLOT), Fracture Closure Pressure (FCP), or combinations thereof.

In some embodiments, a method for determining three-dimensional minimum horizontal stress in a naturally fractured hydrocarbon reservoir is provided. The method includes obtaining reservoir parameters representing properties of the subsurface reservoir for processing in a data processing system, and forming a discrete fracture network by processing the obtained reservoir parameters in the data processing system to identify the presence and extent of natural fractures at locations in the subsurface hydrocarbon reservoir. The method also includes determining, by the data processing system and using the discrete fracture network, a fracture density index (FDI), such that determining, using the discrete fracture network, a fracture density index (FDI) includes generating a raster map from the discrete fracture network, the raster map representing a fracture density per area. The method further includes receiving, at the data processing system, first formation testing data produced by one or more formation tests, the formation tests include a leak-off test (LOT), a formation integrity test (FIT), and an extended leak-off test (XLOT), and receiving, at the data processing system, second formation testing data produced by a diagnostic fracture injection test (DFIT). The method also includes determining, by the data processing system, three-dimensional (3D) minimum horizontal stress horizontal stress in the naturally fractured hydrocarbon reservoir using a machine learning model receiving, as input, the reservoir parameters, the fracture density index, the first formation testing data, and the second first formation testing data.

In some embodiments, the reservoir parameters include seismic attributes from seismic surveys of the subsurface geological structure. In some embodiments, the properties include geomechanical properties that include Young's modulus, Poisson's ratio, unconfined compressive strength, of any combination thereof. In some embodiments, the properties include geomechanical properties that include bulk density, vertical stress, pore pressure, or any combination thereof. In some embodiments, the method includes determining a sweet spot for hydraulic fracturing stimulation based on the 3D minimum horizontal stress. In some embodiments, the method includes performing a hydraulic fracturing stimulation operation based on the determined sweet spot. In some embodiments, the method includes performing the diagnostic fracture injection test (DFIT).

In another embodiment, a non-transitory computer-readable storage medium having executable code stored thereon for determining three-dimensional minimum horizontal stress in a naturally fractured hydrocarbon reservoir is provided. The executable code includes a set of instructions that causes a processor to perform operations that includes obtaining reservoir parameters representing properties of the subsurface reservoir, and forming a discrete fracture network by processing the obtained reservoir parameters to identify the presence and extent of natural fractures at locations in the subsurface hydrocarbon reservoir. The instructions also include determining, using the discrete fracture network, a fracture density index (FDI), such that determining, using the discrete fracture network, the fracture density index (FDI) includes generating a raster map from the discrete fracture network, the raster map representing a fracture density per area. The instructions further include receiving first formation testing data produced by one or more formation tests, the formation tests include a leak-off test (LOT), a formation integrity test (FIT), and an extended leak-off test (XLOT), and receiving second formation testing data produced by a diagnostic fracture injection test (DFIT). The instructions also include determining three-dimensional (3D) minimum horizontal stress horizontal stress in the naturally fractured hydrocarbon reservoir using a machine learning model receiving, as input, the reservoir parameters, the fracture density index, the first formation testing data, and the second first formation testing data.

In some embodiments, the reservoir parameters include seismic attributes from seismic surveys of the subsurface geological structure. In some embodiments, the properties include geomechanical properties that include Young's modulus, Poisson's ratio, unconfined compressive strength, of any combination thereof. In some embodiments, the properties include geomechanical properties that include bulk density, vertical stress, pore pressure, or any combination thereof. In some embodiments, the instructions include determining a sweet spot for hydraulic fracturing stimulation based on the 3D minimum horizontal stress. In some embodiments, the instructions include controlling a hydraulic fracturing stimulation operation based on the determined sweet spot.

In another embodiment, a system for determining three-dimensional minimum horizontal stress in a naturally fractured hydrocarbon reservoir is provided. The system includes a processor and a non-transitory computer-readable memory accessible by the processor and having executable code stored thereon. The executable code includes a set of instructions that causes a processor to perform operations that include obtaining reservoir parameters representing properties of the subsurface reservoir, and forming a discrete fracture network by processing the obtained reservoir parameters to identify the presence and extent of natural fractures at locations in the subsurface hydrocarbon reservoir. The instructions also include determining, using the discrete fracture network, a fracture density index (FDI), such that determining, using the discrete fracture network, the fracture density index (FDI) includes generating a raster map from the discrete fracture network, the raster map representing a fracture density per area. The instructions further include receiving first formation testing data produced by one or more formation tests, the formation tests include a leak-off test (LOT), a formation integrity test (FIT), and an extended leak-off test (XLOT), and receiving second formation testing data produced by a diagnostic fracture injection test (DFIT). The instructions also include determining three-dimensional (3D) minimum horizontal stress horizontal stress in the naturally fractured hydrocarbon reservoir using a machine learning model receiving, as input, the reservoir parameters, the fracture density index, the first formation testing data, and the second first formation testing data.

In some embodiments, the reservoir parameters include seismic attributes from seismic surveys of the subsurface geological structure. In some embodiments, the properties include geomechanical properties that include Young's modulus, Poisson's ratio, unconfined compressive strength, of any combination thereof. In some embodiments, the properties include geomechanical properties that include bulk density, vertical stress, pore pressure, or any combination thereof. In some embodiments, the instructions include determining a sweet spot for hydraulic fracturing stimulation based on the 3D minimum horizontal stress. In some embodiments, the instructions include controlling a hydraulic fracturing stimulation operation based on the determined sweet spot.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a process for a determination of 3D minimum horizontal stress in a naturally fractured hydrocarbon reservoir in accordance with an embodiment of the disclosure;

FIG. 2 depicts a porosity distribution within a 3D grid model in accordance with an embodiment of the disclosure;

FIG. 3 depicts a Young's modulus distribution within a 3D grid model in accordance with an embodiment of the disclosure;

FIG. 4 depicts a Poisson's ratio distribution within a 3D grid model in accordance with an embodiment of the disclosure;

FIG. 5A is a graph depicting a correlation between uniaxial compressive strength (UCS) and porosity in accordance with an embodiment of the disclosure;

FIG. 5B is a graph depicting a correlation between uniaxial compressive strength (UCS) and Young's modulus in accordance with an embodiment of the disclosure;

FIG. 6 depicts a uniaxial compressive strength (UCS) distribution within a 3D grid model in accordance with an embodiment of the disclosure;

FIGS. 7A and 7B are block diagrams of a process for determining a natural fracture distribution of a 3D fracture model in accordance with an embodiment of the disclosure;

FIG. 8 is a block diagram of a process of the determination of 2D/3D geomechanics forward model in accordance with an embodiment of the disclosure;

FIG. 9 depicts a fracture density index in a region of interest in accordance with an embodiment of the disclosure;

FIG. 10 is a plot of an example leak-off test in accordance with an embodiment of the present disclosure;

FIG. 11 is a plot of a diagnostic fracture injection test (DFIT) in accordance with an embodiment of the disclosure;

FIG. 12 depicts an example Talley-Nolte After-Closure Analysis (ACA) flow regime plot from a pressure dependent leak-off (PDL) test in accordance with an embodiment of the disclosure;

FIG. 13 depicts a plot of the prediction accuracy for a machine learning model trained using extreme gradient boosting in accordance with an embodiment of the disclosure;

FIG. 14 is a line chart of the seven most important features in predicting minimum horizontal stress;

FIG. 15 depicts a 3D minimum horizontal stress magnitude within a 3D grid model in accordance with an embodiment of the disclosure; and

FIG. 16 is a block diagram of a data processing system in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to determining of the three-dimensional (3D) minimum horizontal stress magnitude from mechanical properties, rock strength properties, reservoir pressure, vertical stress, and a fracture density index distributed across a 3D geological grid, as well as observation points such as Formation Integrity Test (FIT), Leak off test (LOT), extended leak off test (XLOT), Fracture Closure Pressure (FCP), or any combination thereof. The 3D) minimum horizontal stress magnitude may be used to determine sweet spots for hydraulic fracturing operations in a hydrocarbon-bearing formation (that is a formation containing a hydrocarbon reservoir).

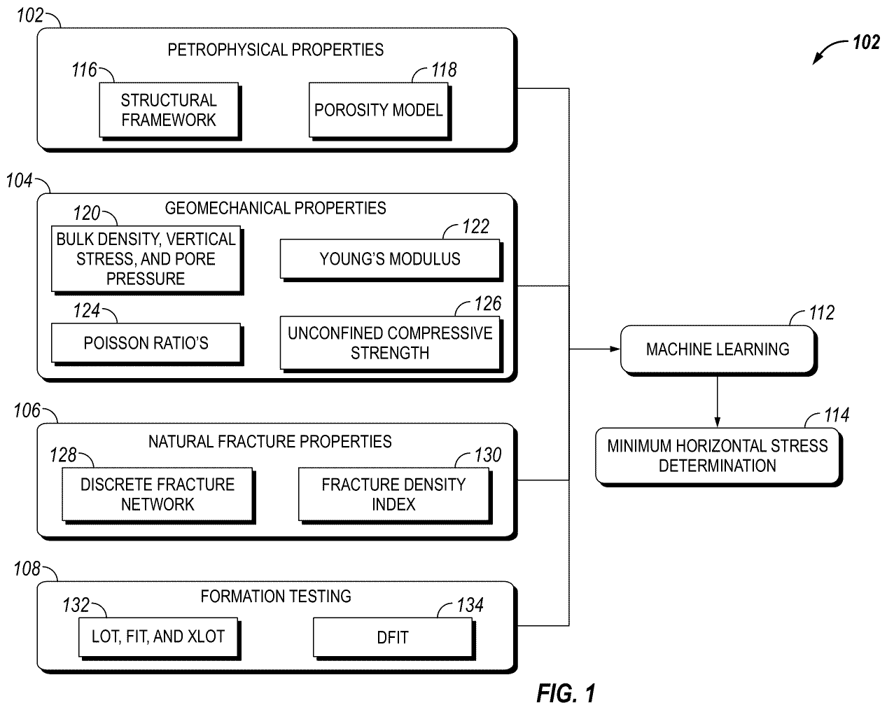

FIG. 1 depicts a process 100 for a determination of 3D minimum horizontal stress in a naturally fractured hydrocarbon reservoir in accordance with an embodiment of the disclosure. As shown in FIG. 1, the process 100 may determine and use four geological components: petrophysical properties (block 102), geomechanical properties (block 104), natural fracture properties (block 106), and formation integrity testing (block 108). The process further includes performing machine learning (block 110) on the geological components and determining a minimum horizontal stress using the machine learning model (block 112).

The petrophysical properties (block 102) may include properties such as porosity, clay volume, permeability, water saturation, and any combination thereof. In some embodiments, these properties may be determined by a petrophysical interpretation and may be used to determine possible intervals in the well that have relatively high fluid saturation or relatively high porosity and permeability. In some embodiments, the petrophysical properties may be extrapolated within a 3D grid model using known geostatic techniques. Such techniques may include kriging (also referred to as “Gaussian process regression”), sequential Gaussian simulation (SGS), or other suitable techniques.

As shown in FIG. 1, determination of the petrophysical properties (block 102) may include determining a structural framework (block 116) and determining a porosity model (118). The structural framework may be built using well tops information by spatially interpretating the points using suitable software platforms, such as Petrel™ manufacture by Schlumberger Limited of Houston, TX, USA, or Gocad® by Mira Geoscience of Quebec, Montreal, Canada. Determining the structural framework may include adding faults and layers according to the reservoir features.

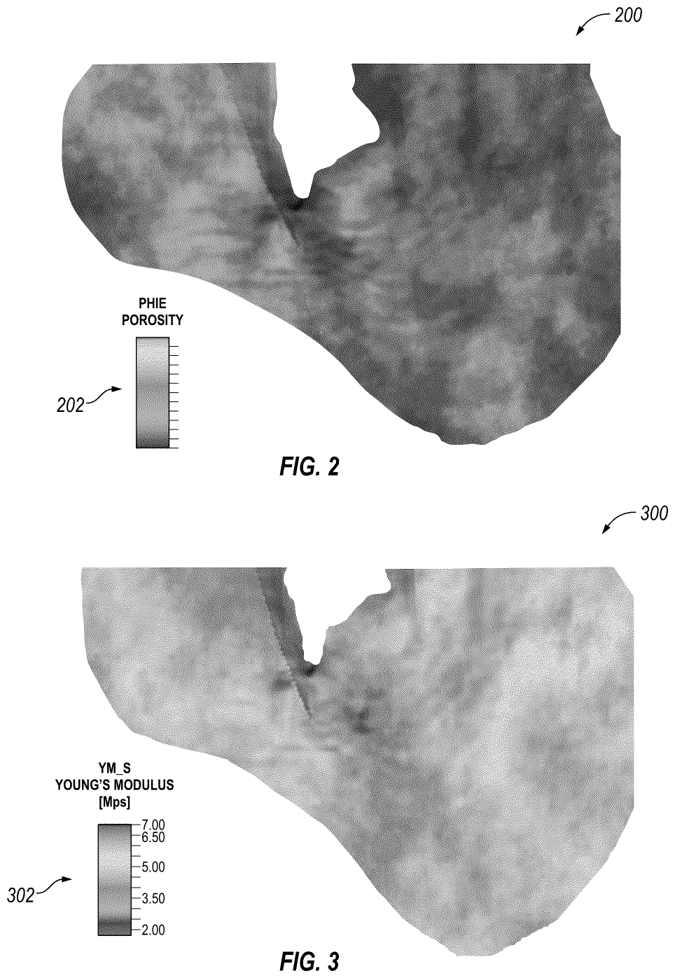

As mentioned supra, determination of the petrophysical properties (block 102) may include determining a porosity model (block 118). In some embodiments, porosity may be determined from wireline logs of a well accessing a hydrocarbon reservoir, core plugs measurement from the well accessing the hydrocarbon reservoir, or both. Such wireline logs may include bulk density logs, gamma ray logs, neutron logs, or a combination thereof. In some embodiments, the porosity may be extrapolated into a 3D grid model using a co-kriging algorithm, followed by an additional or secondary property. In some embodiments, the additional property may include acoustic impedance extracted from seismic volume cube, facies or other type of guide, such as described in Mojeddifar et al., Porosity prediction seismic inversion of a similarity attribute based on a pseudo-forward equation (PFE): a case study from the North Sea Basin, Netherlands. Pet. Sci. 12 (2015), pp. 428-442. By way of example, FIG. 2 depicts a porosity distribution within a 3D grid model 200 in accordance with an embodiment of the disclosure. As shown in FIG. 2, the effective porosity (PHIE) is shown in different colors indicated by the color legend 202.

As shown in FIG. 1, the process 100 may include the determination of geomechanical properties (block 104). The determination of geomechanical properties (block 104) may include determining bulk density, vertical stress, and pore pressure (block 120), determining Young's modulus (block 122), determining Poisson's ratio (block 124), and determining unconfined compressive strength (block 126).

The determination of bulk density, vertical stress, and pore pressure (block 120) may be determined from bulk density logs and pore pressure. In some embodiments, rock physics analysis may be used to remove the environmental and gas effects from the bulk density log response and improve reliability of determined mechanical properties. After the acoustic log is corrected, an extrapolation inside the 3D grid model may be performed by using a geostatistics algorithm, which can be collocated with additional variables in order to guide the extrapolation and improve consistency, as described in Reservoir Stress Path from 4D Coupled High Resolution Geomechanics Model: A Case Study for Jauf Formation, North Ghawar, Saudi Arabia, THE SAUDI ARAMCO JOURNAL OF TECHNOLOGY (Fall 2016). Additionally, vertical stress may be estimated utilizing the bulk density and pore pressure at initial conditions can be recorded utilizing a modular formation dynamics tool (MDT), drill stem test (DST), or other suitable tools or techniques.

The determination of geomechanical properties (block 104) may also a determination of Young's modulus (block 122) and a determination of Poisson's ratio (block 124). In some embodiments, Young's modulus and Poisson's ratio may be determined from acoustic wave and bulk density logs. The logs profile may produce a dynamic response which may be transformed to static (that is, calibrated) mechanical logs, as described in U.S. Pat. No. 11,098,582, a copy of which is incorporated by reference.

In such embodiments, rock physics may be determined from the correction of a sonic acoustic well logs and bulk density logs. this process may include obtaining well logs such as sonic logs and density logs and normalizing the sonic logs and density logs as is known in the art. The sonic logs and density logs may be modeled for washouts, missing sections, gas zones, and other conditions Dynamic elastic properties may be determined from the logs In some embodiments, the determined properties may be evaluated for quality control against measured data or laboratory determinations.

In some embodiments, dynamic Young's modulus and Poisson's ratio for reservoir rock may be generated using compressional sonic logs, shear sonic logs and density logs obtained from well logging tools. Well logs, such as bulk density logs and acoustic sonic logs, may be corrected due to the effects of hole condition such as borehole wall rugosity (that is, washouts) and natural gas in rocks. In some embodiments, a bulk density log may be reconstructed from logs of the mineral rock volumes, porosity, and mineral density. In some embodiments, acoustic sonic logs (that is, sonic log velocities) may be reconstructed using formation rock models.

The rock physics may be focused on predicting dynamic pressure wave velocity Vₚ and shear wave velocity Vₛ as accurately as possible, which is suitable for further mechanical modeling. By using the porosity and clay content from well logs, an analysis of which rock physics models are most suitable may be performed. Several techniques such as Advanced Differential Effective Medium (DEM) to estimate P-wave and S-wave velocities are available in Techlog™ 2017 platform suite available from Schlumberger Ltd of Houston, TX, USA. A tangential shear factor may be introduced to obtain optimal match with observed Vₚ/Vₛ ratios in the sandstones, since contact theory is known to over predict shear wave velocities by neglecting rotational freedom and slip at grain contacts. Vₚ and Vₛ are functions of porosity, clay content, differential pressure, and saturation. The setup of input parameters may be completed iteratively to find the best solid clay properties to be used for this dataset; that is, inverting for solid clay elasticity for the dataset, assuming that all other properties are known, and the model is correct. Calculated Vₚ and Vₛ may be calibrated with dynamic mechanical properties derived from core analysis to obtain the best fit between all available data.

The rock physics model may be formed based on physical principles to generate P-wave and S-wave velocities based on rock structure, composition, and properties. By assigning known values to certain of these formation rock parameters, such as clay and sand bulk- and shear-modulus, model velocities can also be obtained in corrupted intervals. The main advantage of this approach is that all relation between elastic properties and rock quality are preserved.

In some embodiments, static properties may be determined using empirical correlations from triaxial rock mechanical tests. In such embodiments, relationships between the static Young's modulus and dynamic Young's modulus may be derived from the triaxial rock mechanical tests and compared with the properties determined from sonic well logs. For example, the tests of rock samples may include single or multi-stage tri-axial rock mechanical tests to provide data representing measures rock strength and mechanical conditions to simulate in-situ stress conditions providing compressive strength and static values of elastic constants of the rock.

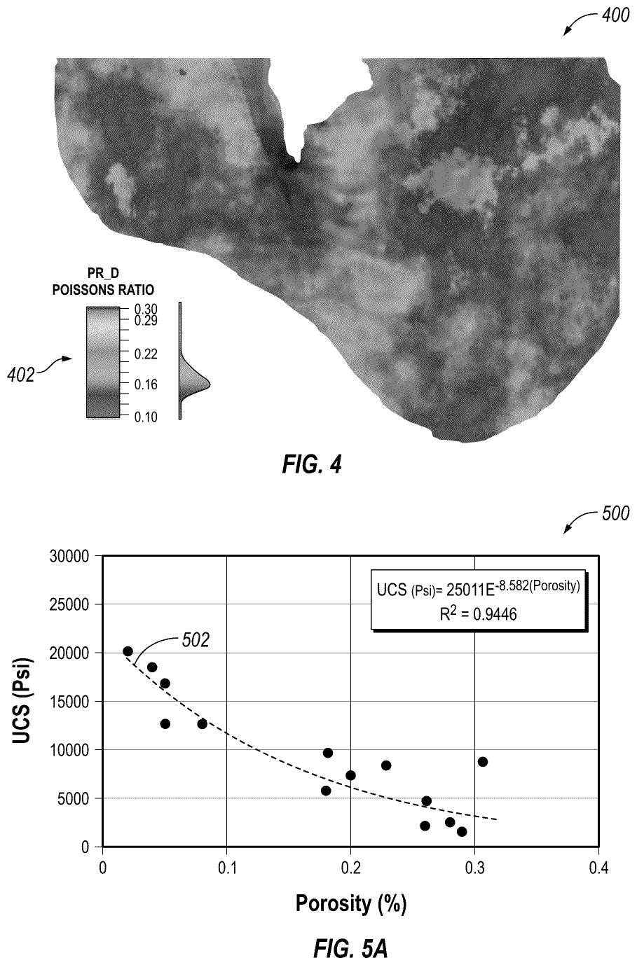

The extrapolation of Young's modulus and Poisson's ratio inside the 3D grid model may be performed by modeling the parameters using 3D seismic attributes or geostatic methods as a guide elastic property. By way of example, FIG. 3 depicts a Young's modulus distribution within a 3D grid model 300 in accordance with an embodiment of the disclosure. As shown in FIG. 3, the Young's modulus (in mega pounds per square inch (Mpsi) is shown in different colors indicated by the color legend 302. In another example, FIG. 4 depicts a Poisson's ratio distribution within a 3D grid model 400 in accordance with an embodiment of the disclosure. As shown in FIG. 4, the Poisson's ratio (in mega pounds per square inch (Mpsi) is shown in different colors indicated by the color legend 302.

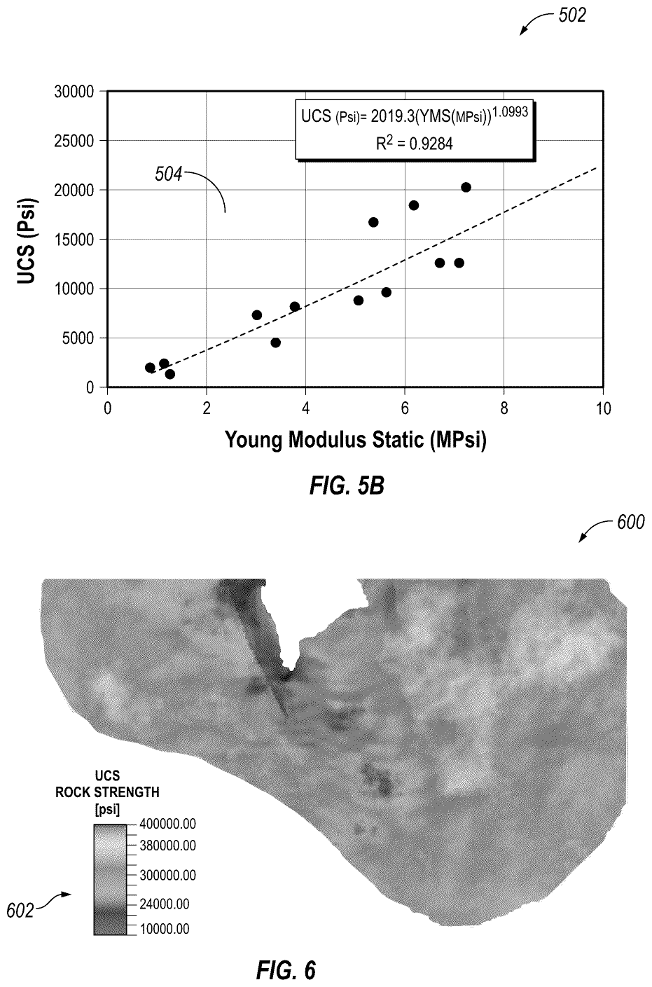

The determination of geomechanical properties (block 104) also includes a determination of uniaxial compressive strength (block 126). The uniaxial compressive strength may be determine using a rock mechanical correlation between static properties such as Young's modulus or porosity. In some embodiments, the rock mechanical correlations may be obtained from an unconfined compressive test. In other embodiments, the rock mechanical correlations may be obtained from a multistage triaxial test, such as also discussed above. By way of example, FIG. 5A is a graph 500 depicting a correlation (line 502) between uniaxial compressive strength (UCS) (in psi) and porosity (in %) in accordance with an embodiment of the disclosure. In another example, FIG. 5B is a graph 504 depicting a correlation (line 506) between uniaxial compressive strength (UCS) (in psi) and Young's modulus (in Mpsi) in accordance with an embodiment of the disclosure. The correlation may be used to determine a uniaxial compressive strength distribution in a 3D grid model. For example, FIG. 6 depicts a uniaxial compressive strength (UCS) distribution (in psi) within a 3D grid model 600 in accordance with an embodiment of the disclosure. As shown in FIG. 6, the uniaxial compressive strength (UCS) (in psi) is shown in different colors indicated by the color legend 602.

As also shown in FIG. 1, natural fracture properties may be determined (block 106). The determination may include determining a discrete fracture network (block 128) and a fracture density index (block 130).

The discrete fracture network determination (block 122) may include 3D numerical deformation and geomechanical modeling that evaluates natural fracture occurrence as the result of the episodic tectonic history, geomechanical facies, and the interaction of natural fractures with in situ stresses. The determination of a natural fracture distribution of a 3D fracture model using geomechanics (block 102) may use rock mechanical properties combined with additional data like seismic, structural restoration and geomechanics determine the natural fractures. In some embodiments, the determination of a 3D fracture model and a natural fracture distribution may be performed according to the techniques described in U.S. Pat. No. 10,607,043 filed Sep. 14, 2017, and titled “SUBSURFACE RESERVOIR MODEL WITH 3D NATURAL FRACTURES PREDICTION,” a copy of which is incorporated by reference in its entirety.

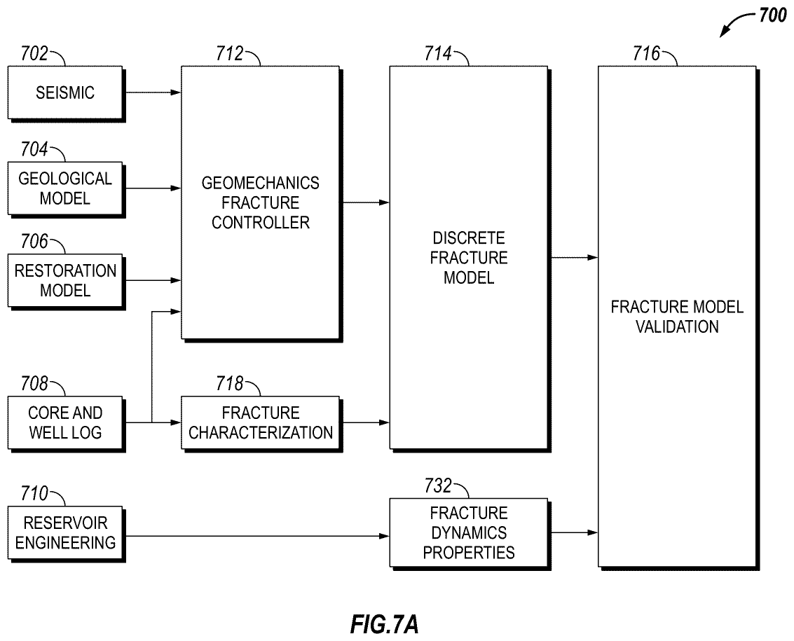

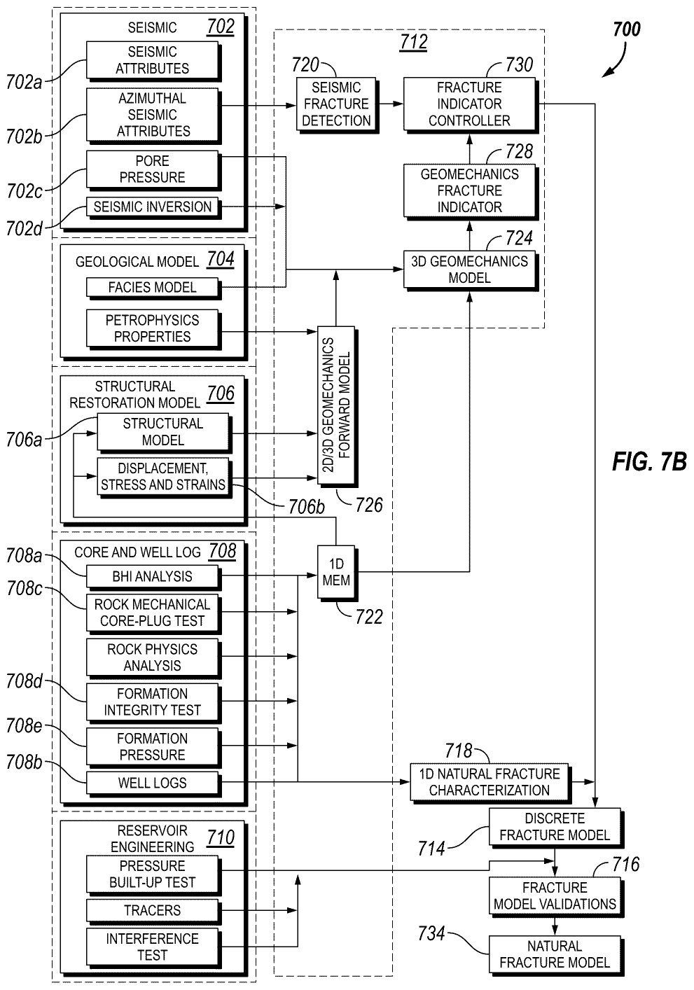

FIGS. 7A and 7B depicts a process 700 for determining a natural fracture distribution of a 3D fracture model in accordance with an embodiment of the disclosure. The inputs to the process 700 may include different reservoir parameters and properties obtained via different techniques and known earth science. As shown in FIGS. 7A and 7B, such inputs may include seismic attributes from seismic surveys (702); rock and mechanical properties from geological modeling (704); measures from structural restoration models (706); core and well logs (708) obtained from formation core samples and well logs performed in wellbores drilling into the reservoir; and reservoir engineering measures obtained (710) from production measures and reservoir simulations of a reservoir layer.

The process 700 may include a geomechanics fracture controller (712), determining a discrete fracture model (714), and validating the fracture model (716). The geomechanics fracture controller (712) may integrate the paleo-stress from structural restoration model (706) obtained for several stages in geological time, and current stress regime conditions obtained through a geomechanical numerical simulation model. In some embodiments, geomechanics fracture controller (712) may apply seismic volume interpretation techniques and attributes to detect possible faults and natural fractures alignments by using post stack discontinuities attributes, azimuthal analysis, and elastic seismic inversion.

The determination of the natural fracture model (714) may include quantifying fracture density in the subsurface reservoir layer using the output from the geomechanics fracture controller (712), and a 1D fracture characterization (718) provided from core samples and borehole well log images from a borehole image (BHI) analysis process 708a (shown in FIG. 7B). The determination of the natural fracture model (714) also includes the determination of fracture dimensions and their properties into the discrete fracture model, described in the disclosure. Examples of the fracture properties resulting from the determination of the natural fracture model (714) include fracture position, orientation, geometry, porosity, aperture, permeability, and the like. In other embodiments, other fracture properties may also be estimated during the determination of the natural fracture model (714).

The validation of the fracture model (716) may include cross-checking or validating the model using reservoir production data. In some embodiments, the natural fracture model may be upscaled to conform to a fine-scale cell grid of geological model and reproduce the natural fracture distribution and their properties, for comparison with the reservoir production data for validation proposes. Several types of reservoir production data can be used to calibrate the fracture models with reservoir engineering data. Examples of such reservoir production data are results of measures obtained from: PTA (Pressure Transient Analysis), tracers, drilling operation events, PLT (production logs), and the like. In other embodiments, other reservoir production data can also be used for cross-checking during the validation of the fracture model (716).

FIG. 7B depicts aspects of the geomechanics fracture controller (712) in further detail in accordance with an embodiment of the disclosure. As shown in FIG. 7B, a seismic fracture detection process (720) is provided with seismic attributes (707A) obtained from seismic volume results (702). The seismic attributes (707A) may include attributes related to natural fractures detections or dislocation detections. Examples of such attributes obtained from the seismic dislocations attribute analysis results may include: variance, anti-tracking, flatness, curvature, and the like. In other embodiments, other seismic attributes may also be provided. As will be appreciated, seismic fracture attributes may be unable to be compared straight forward at wellbore scale due to resolutions issues. However, seismic attributes may be used as a seismic fracture controller or conduct for minor fractures detected at wellbore scale if the relations regarding to the locations and intensity between them exist.

As shown in FIG. 7B, advance seismic fracture detection may also be performed during the seismic fracture detection process (720) using azimuthal seismic analysis (707B) to capture the variations of the wave propagation at different directions. Such variations in wave propagation form anisotropic volumes in the reservoir layer and are helpful in detecting fractures. This azimuthal analysis may be based on whether the anisotropy response in the reservoir is due to natural fractures or caused by another reason. In order to identify whether the anisotropy response may be azimuthal shear anisotropy, sonic acoustic acquisition may be performed at a well location in the naturally fractured reservoir. An example of azimuthal seismic analysis is described in: Gray, F. D. and Head, K. J., 7000, Fracture Detection in the Manderson Field: A 3D AVAZ Case History: The Leading Edge, Vol. 19, No. 11, 1714-1271; and Khalid Al-Hawas, Mohammed Ameen, Mohammad Wahab, and Ed Nebrija, Saudi Aramco, Dhahran, Saudi Arabia Colin Macbeth, Heriot-Watt University, Edinburgh, U.K., 7003, “Delineation of Fracture Anisotropy Signatures in Wudayhi Field by azimuthal seismic data”, the Leading Edge.

The geomechanics fracture controller (712) may include a determination of a 1D mechanical earth model (MEM) (722) to determine the rock mechanical properties and stress regime conditions in the reservoir layer. The determination of the 1D MEM may include computing the elastic rock mechanical properties deriving from well logs (708b) and rock mechanical test (708c); using additional information such as reservoir formation pressures (708c) and a Formation Integrity Test (FIT) (708d), the in situ stress regime can be predicted and mechanical stratigraphy (Geomechanical Facies) computed. The mechanical stratigraphy may conform the rock mechanical response to the geological deformation process and may be used as constraints for natural fractures presence, constraining their development to some particular layer through brittleness concepts, depending also on the deformation magnitude. Additionally, the maximum horizontal stress direction may be detected by the Borehole Image Analysis (BHI) (708a), and the in situ stress magnitude derived from the 1D MEM may be used to predict the stress regime of a 3D geomechanics model (724) (also referred to as a “3D mechanical earth model (MEM)”).

As shown in FIG. 7B, the geomechanics fracture controller (712) may include the determination of 2D/3D geomechanics forward model (726) that combines a structural model (708a) and displacement, palco-stress, and strain measures 708b from the structural restoration model (708) with petrophysical properties (704b) from geological model (704). The results take the form of structural restoration as horizons displacement and deformation using boundary conditions. The determination of 2D/3D geomechanics forward model (726) may include as a Finite Element Method (FEM) using geomechanics numerical simulation software, to estimate the tensor stress regime corresponding to the deformation estimate from structural restoration at the in situ stress conditions.

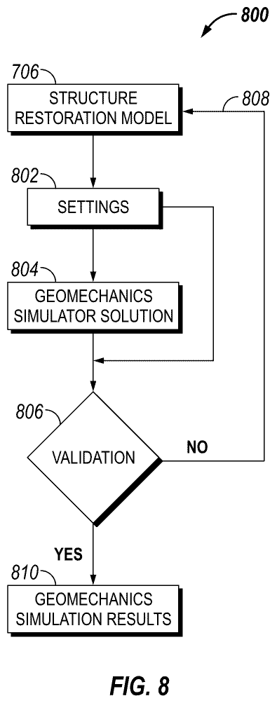

FIG. 8 depicts a process 800 of the determination of 2D/3D geomechanics forward model (726) in accordance with an embodiment of the disclosure. The initial parameter and strain boundary conditions may be defined for the numerical simulation and processing may be iteratively repeated until an equilibrium stress is obtained according to present to in situ stress conditions in the reservoir. As will be appreciated, a number of geomechanics simulator methodologies are commercially available and are able to estimate stress conditions using the deformation model from the structural restoration model. These results can be used to calculated or predict the possible origin for the natural fractures as stretching zones, compression zones which is an input to classify the different kind of natural fractures and their possible orientations from a qualitative perspective, using a strain tensor derivate from the 2D/3D geomechanics forward model (726). Example geomechanics simulator methodologies include ABAQUS™ from Dassault Systemes; VISAGE™ from Schlumberger; and ELFEN™ from Rockfield, COMSOL™ from AltaSim Technologies.

As shown in FIG. 8, input measures from the structural restoration modeling (706) are received for the 2D/3D geomechanics forward model (726) and stored as initial settings (802). The settings (802) are then processed by a geomechanics simulator (804) of the type described above. The output from the geomechanics simulator is then cross-checked or validated (806) against specified stress equilibrium conditions. As shown in FIG. 8, if confirmation results are not achieved during the current iteration (line 808), the previous settings of the step are adjusted for iteration by simulation step. The iterations may be repeated until specified conditions are validated. After validation, the simulation results (810) may be provided as the 2D/3D geomechanics forward model (726) and may indicate conditions of stress, strain and pre-existing faults and fractures in the reservoir layer.

The 3D geomechanics model (724) of the geomechanics fracture controller (712) may include the measures and indications of rock mechanical properties distribution. The 3D geomechanics model (724) may further include elastic rock properties and rock strength throughout the 3D geological grid. The 3D geomechanics model (724) may be calculated by boundary conditions to simulate the in situ stress regime. As discussed in the disclosure, the in situ stress regime is a condition where the stress field is unperturbed or is in equilibrium without any production or influences of perforated wells.

The determination of the 3D geomechanics model (724) may use elastic seismic inversion (702d) in the form of acoustic impedance, bulk density, and may also include pore pressure (702c) covering the 3D geological model area. The seismic inversion parameters may be obtained from an elastic seismic inversion (702d) and seismic velocity analysis for the pore pressure (702c). The determination of the 3D geomechanics model (724) may also be based on rock mechanical correlations between dynamics and static elastic rock mechanical properties which have been determined as a result of the 1D mechanical earth model (MEM) (722). 3D mechanical stratigraphy may also be calculated using the elastic properties of the 3D geomechanics model (724), and may be used to constrain the fracture distribution using brittleness property definition. An example processing methodology for determining the 3D geomechanics model (724) is described in: Herwanger, J. and Koutsabeloulis, N. C.: “Seismic Geomechanics—How to Build and Calibrate Geomechanical Models using 3D and 4D Seismic Data”, 1 Edn., EAGE Publications b.v., Houten, 181 pp., 7011.

Additionally, geomechanics forward modeling of the type described infra and shown in FIG. 8 may be used as a loop process between the 2D/3D geomechanics forward model (726) and 3D geomechanics model (724). Such a loop process may capture the displacement and deformation quantified in the structural restoration model (706), and may provide more accurate calculations of the strain distribution corresponding to the structural evolution faulting and folding in the model (706).

The determination of the 3D geomechanics model (726) may include a geomechanics fracture indicator (728) that may form indications of fractures based on selected rock mechanical properties distributed for the 3D geomechanics model (724). The mechanical stratigraphy may be defined in the 3D geomechanics model (724) by using the Brittleness concept and may be used as a geomechanics fracture indicator to define the fracture position and density or spacing through the layering. A strain or plastic strain model may be determined in the 2D/3D geomechanics forward model (726) and 3D geomechanics model (724) and may be used as indicator of fracture orientation (dip and azimuth) and possible areal/volumetric density distribution, according to the kind of geological structural environment. Several components of fractures can be considered as geomechanics indicator for fractures, such as fractures relate to folding and fractures related to faulting. The quantifications about the strain may be qualitative in terms of real fracture density present in the reservoir.

As shown in FIG. 7B, the determination of the 3D geomechanics model (724) may include a fracture indicator controller (230). The fracture indicator controller (230) may compare attributes determined from seismic fracture detection (220) and geomechanics fracture indicator (728) in terms of fracture position, fracture density and orientation in a qualitative way, to evaluate possible coincidence zones, between the models, where natural fractures can be expected to be created. In some cases, the attributes determined from seismic fracture detection (270) and geomechanics fracture indicator (728) may be complementary due to the different vertical and areal resolution in which both of them are calculated.

The discrete fracture model (714) may be determined subsequent to identification of natural fracture locations by the fracture indicator controller (730). The discrete fracture model may build a representative natural fracture model based on stochastic mathematical simulations. As shown in FIG. 7B, the discrete fracture model (714) may be constructed from the fracture indicator controller (730) and the intensity and orientation from the 1D natural fracture characterization (718).

The determination of the discrete fracture model (714) may receive as input the results of the 1D natural fracture characterization (718), which may be obtained from the borehole image resistivity analysis or acoustic image interpretation (708a) of the core and well logs (708) and may represent the intensity fracture, aperture, fracture classification and fracture orientation along a wellbore.

As noted infra, the discrete fracture model (714) may be determined using the fracture indicator controller (730) and the 1D natural fracture characterization (718). The determination may constrain the orientation and fracture intensity in a qualitative way, and using the 1D natural fracture characterization (718), may calculate the real fracture intensity quantification. This output can be used to predict a natural fracture model through the discrete fracture network methodology. For fracture intensity quantification purposes the fracture intensity derived from the fracture indicator controller (730) may be normalized for comparison with the BHI fracture intensity derived from the 1D natural fracture characterization (718).

The fracture model validation 716 may validate the discrete fracture model (714). The validation may be performed using reservoir production data. As shown in FIG. 7B, Several types of data may be used as fracture dynamic properties (732) to calibrate the fracture model with reservoir engineering measures (710). For example, results from a PTA (Pressure Transient Analysis) test, or measures from tracers, drilling operations, production logs, and the like may be used. For example, pressure transient analysis can estimate permeability contribution due to fracture presence and the capacity for fluid flow due to the fractures presence. In another example, tracer injection, production logs, interference test and possibly some drilling events as can indicate mud loss circulation that can provide evidence of the presence of natural fractures. The discrete fracture model (714) may upscale into the fine-scale cell grid geological model, and reproduce the natural fracture distribution and their properties to compare with the validation data.

After the fracture model validation, a discrete natural fracture network (128) may be produced as a result of the process 700. As previously described, the discrete natural fracture model (128) may indicate the presence and extent of natural fractures in the subsurface geological structures.

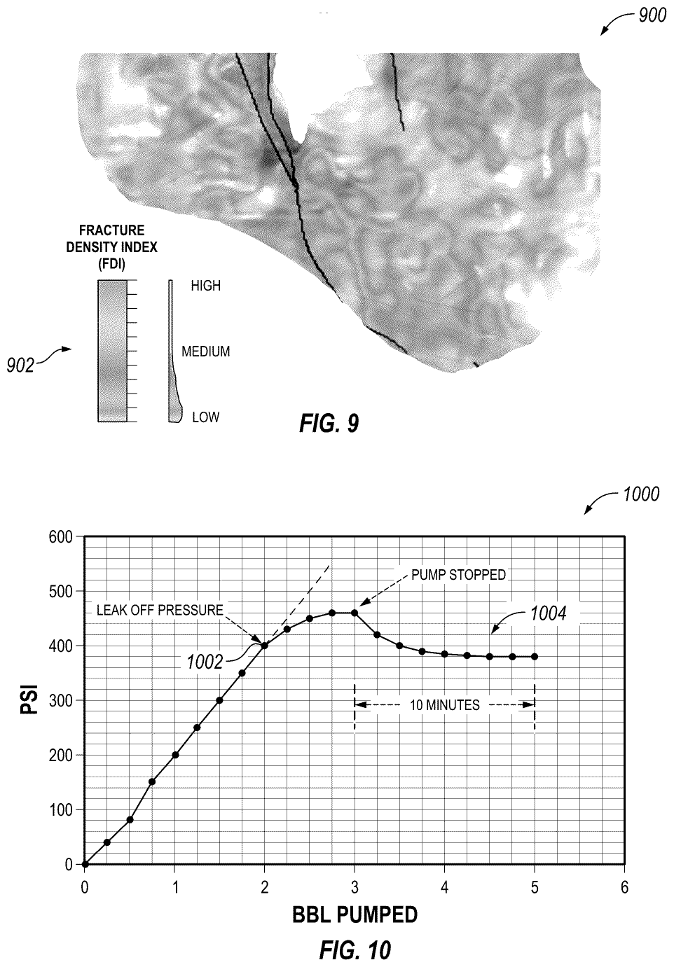

Additionally, a fracture density index (FDI) may be determined (block 130). The fracture density index (FDI) represents critical stress fluid pathways in the region of interest. The fracture density index (FDI) determination may include converting the discrete fracture network (block 128) into two dimensional (2D) lines to compute a continuous fracture density property, such as described in U.S. Pat. No. 10,607,043, a copy of which is incorporated by reference in its entirety. For example, various geographic information systems (GIS) geoprocessing software may have tools for computing line density. In some embodiments, the conversion of a 3D discrete fracture network to 2D lines may be performed by ArcGIS available from Environmental Systems Research Institute (Ersi), California, USA. In such embodiments, a raster map representing fracture density per area may be generated. Additionally, a suitable color-indexed palette may be assigned to enable visual identification of areas where natural fractures are more concentrated. For example, FIG. 9 depicts a fracture density index 900 in a region of interest in accordance with an embodiment of the disclosure. As shown in FIG. 9, the fracture density index is shown in different colors indicated by the color legend 902.

Additionally, as shown in FIG. 1, formation testing may be performed (block 108). The formation tests may include one or more of: a leak-off test (LOF), formation integrity test (FIT), and an extended leak-off test (LOF) (block 132). The formation integrity test may also include a diagnostic fracture injection test (DFIT) (block 134). These tests may aid in determination of fracture closure pressure (FCP) (defined herein as the fluid pressure needed to initiate the opening of a fracture). As will be appreciated, fracture closure pressure is equal to the minimum in-situ stress, because the pressure required to open a fracture is the same as the pressure required to counteract the stress in the rock perpendicular to the fracture.

A formation integrity test (FIT), also referred to as a formation pressure-integrity test, measures formation strength and may be performed at the end of drilling a section and after the drilled section has been cased-off with a liner or casing. In some embodiments, 3 feet (ft) to 5 ft of new formation may be drilled below the last casing shoe depth. The formation pressure-integrity test may then be conducted by closing in the well with the blowout preventer, then slowly pumping drilling fluid into the wellbore at a constant rate in the range of 0.25 barrels per min (bbl/min) to 0.5 bbl/min. The pressure in the entire hydraulic system will then increase until the standpipe pressure indicates that the formation is beginning to yield.

To conduct a leakoff test (LOT), a constant pressure increment may be applied for each increment of drilling fluid pumped, so the earlier portion of the test data falls on a straight line. This straight line may continue until the point where the formation starts to move apart and begins to take on mud. The pressure at this point is called the leakoff pressure and may be used to calculate the formation fracture gradient. By way of example, FIG. 10 is a plot 1000 of an example leak-off test in accordance with an embodiment of the present disclosure. The plot 1000 shows pressure (in psi) on the y-axis vs barrels (bbl) pumped on the x-axis. The leakoff pressure is depicted at point 1002 as determined according to the techniques described herein.

After reaching the leakoff point, the pumping may be continued long enough to ensure that fracture pressure is reached. The pumping is then stopped and the well left shut-in to observe pressure-decline rate, which is indicative of the rate that mud or mud filtrate is being lost (such as shown by line portion 1004 of FIG. 10). If pumping continues beyond the fracture-initiation point, the formation may breakdown, leading to pressure decline and fracture propagation. Thus, the formation pressure-integrity test (FIT) described supra is performed in a similar manner to a leak-off test (LOT) except that the upper limit of the test is preset to a certain mud density gradient which is generally lower than the leak-off point pressure.

In such tests, test signature interpretation may be as important as the accuracy of the absolute value obtained. To estimate downhole pressure from surface measurements before the well is tested, the drilling fluid may be circulated bottoms-up to condition the mud. This ensures that a homogeneous mud column of a known density is between the surface and the casing shoe. Additionally, mud type is also important in leakoff-test-interpretation accuracy. Leakoff testing with oil-based muds (OBM's) or synthetic-based muds (SBM's) may have differ considerations. For example, the high compressibility of synthetic muds may be problematic when drilling deep-water or high pressure high temperature (HPHT) wells. The wellbore temperature profile along the well path may also have a significant effect on the circulating temperature for the whole well and affects mud density and viscosity. If the formation is broken down during testing with an OBM, the formation may not heal and regain the strength it had before the test. Thus, in some embodiments, the leakoff test may be performed with a water-based mud (WBM) which is then displace with OBM for subsequent drilling. Additionally, in some embodiments, downhole pressure measurements using annular-pressure-while-drilling sensors may be used to assist in minimizing or removing uncertainties caused by anomalies in mud gel strength or in homogeneities in the mud column caused by pressure and temperature effects. The downhole pressure data may be obtained at (that is, transmitted to) the surface in real time to avoid fracturing the formation during the test.

In some embodiments, wireline formation testers (WFTs) may be used to perform leak-off test (LOT) and microfracturing by injection into a tight formation, using either wellbore fluids or special fluids carried with the tool from the surface. Due to negligible wellbore storage, the injection pressure is instantly transmitted to the formation, causing a rapid increase in fluid pressure around the wellbore. The formation will then fracture when this pressure increase exceeds the rock minimum stress, causing the fluid pressure to decline rapidly with increased surface area and greater fluid leakoff into the formation. After the injection ceases, the fluid pressure quickly dissipates, causing the fracture to close. Because of the fast nature of fracturing and fracture closing, several injection and falloff periods may be performed with a wireline formation tester (WFT) within a shorter time period than when using a surface diagnostic fracture injection test (DFIT) with one surface-induced minifracture followed by a falloff.

Additionally, the formation integrity test (block 108) may also include a diagnostic fracture injection test (DFIT) (block 128). A diagnostic fracture injection test (DFIT) (also known as a mini-falloff (MFO)) test, is a type of pre-main frac dynamic calibration test that may be performed to further executed to gather information about the reservoir. As used in embodiments of the disclosure, a diagnostic fracture injection test (DFIT) is a small volume, plain water, pump-in treatments from the surface into the well that can provide information for designing fracturing treatments and characterizing a reservoir. In contrast to the leak-off tests and fracture injection tests (FIT) describes supra, the DFIT is performed in completed wells through perforations in a casing or a frac port in an openhole completion.

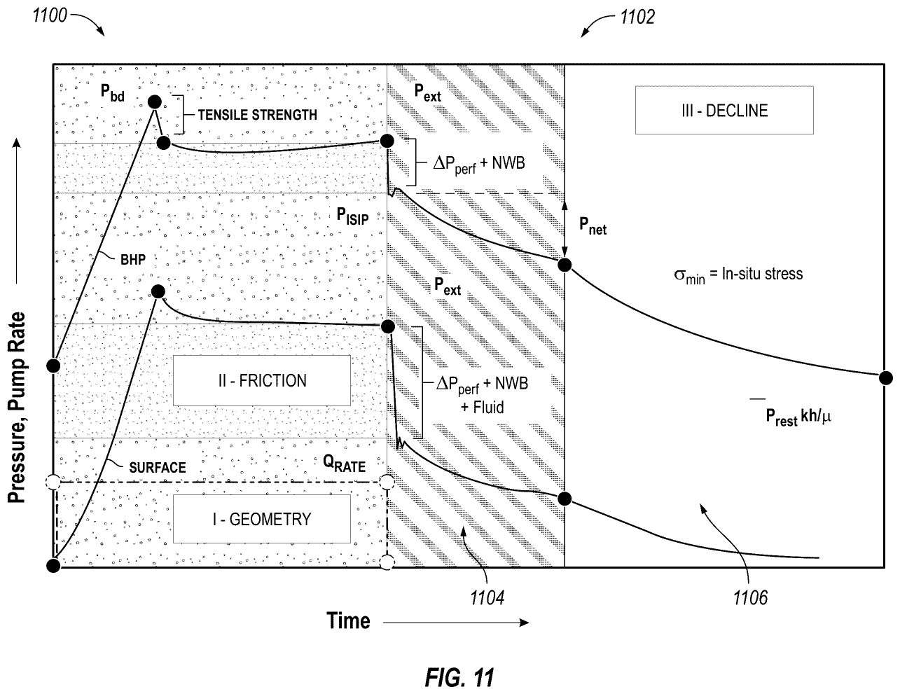

By way of example, FIG. 11 is a plot of a diagnostic fracture injection test (DFIT) in accordance with an embodiment of the disclosure. The plot 1100 depicts a pressure response on the y-axis and time on the x-axis, and is generated from a constant injection rate. As shown in FIG. 11, in the early part of the injection test the pressure (surface and downhole) increases until the pumping is stopped following which a pressure decline (region 1102) ensues thereafter. The two distinct periods in the chart below are a) the formation breakdown and fracture extension period, and b) the pressure falloff period following the cessation of pumping into the formation. The pressure decline may be analyzed in two main phases; i) before closure (BC) of the fracture (region 1104); that is, until the pressure reaches minimum in-situ stress (or Pclosure) point 1106 in FIG. 9 and ii) after closure (AC) of the fracture (region 1108), where the pressure drops below the Pclosure until the pressure decline test is terminated.

In embodiments of the disclosure, a diagnostic fracture injection test (DFIT) may provide important data to aid in reservoir development. In certain embodiments, the data may include: reservoir pore pressure, detailed closure and fracture gradients, process zone stresses (PZS, also known as net pressure), transmissibility (in formation permability⋅formation thickness per viscosity (kh/μ)) values which can be converted into reservoir permeability values, and leak-off mechanisms. Advantageously, a DFIT may provide meaningful reservoir information in relatively short test times which otherwise could take months or even years to reach pseudo-radial flow regime in tight reservoirs.

The DFIT analysis can become challenging in naturally fractured reservoirs where the PDL effect can be prominent, there may be multiple fracture closure points making it difficult to identify the pertinent fracture closure pressure (FCP), or a very high fluid leak-off that results in abrupt and immediate closure of the fracture leaving no opportunity to capture the data. Depending on the orientation of the natural fractures they can behave as competing fractures to the main fracture causing high treating pressures and arresting the development of the fracture. These events depend on the fracture distribution, density, stress regime and orientation.

### Pressure Fall-Off Analysis

Embodiments of the disclosure may further include a pressure fall-off analysis. After the cessation of pumping in a diagnostic fracture injection test (DFIT), a pressure decline may be analyzed for fracture closure, as discussed supra. Conventional pressure decline analysis from a fracture injection is based on ideal rock conditions, that is, an ideal hydraulic fracture developing in a perfectly linear-elastic, infinite, isotropic, homogeneous medium of constant permeability, pore pressure and closure stress. Under such interpretations, the fracture must be a single planar fracture adhering to the PKN geometry assumption of constant height, constant area, constant leak-off coefficient and constant compliance. However, such reservoirs rarely exist in these ideal conditions; thus, the non-linear behavior of the pressure fall-off on a G-function plot to an ideal fracture behavior can be the result of fracture geometry effects such as PDL (pressure dependent leakoff), fracture tip extension, fracture height recession or existence of variable storage in a transverse fracture system. In some embodiments, consistent fracture closure time and closure stress and the identification of transient flow regimes may be obtained from supplementary plots of square root of shut-in time and the log-log plot of pressure changes (and their derivatives). In other embodiments, other techniques for analyzing the pressure decline may be used so long as such techniques include the correct selection of pressure events (such as closure pressure) to ensure the correct interpretation of data. Additionally, embodiments of the disclosure include a consistent relationship between pre-closure analysis (i.e., parameters measured until reach closure pressure) to after-closure analysis (i.e., reservoir pressure, transmissibility, formation perm). In such embodiments, the after-closure analysis may include identification of transient flow regimes (like fracture linear flow, bi-linear flow, to reservoir linear flow, pseudo-radial flow).

### Pre-Closure Analysis

The analysis of pre-closure data may use four possible conditions for fracture closure: 1) Normal fracture closure dominated by matrix leak-off with a constant fracture surface area after shut-in; 2) Pressure dependent leak-off (PDL) in a reservoir with pressure-variable permeability of flow capacity caused by natural or induced secondary fractures or fissures; 3) Fracture tip extension after shut-in and 4) Fracture height recession during closure, but which can also indicate variable storage in a transverse fracture system.

### After-Closure Analysis (ACA)

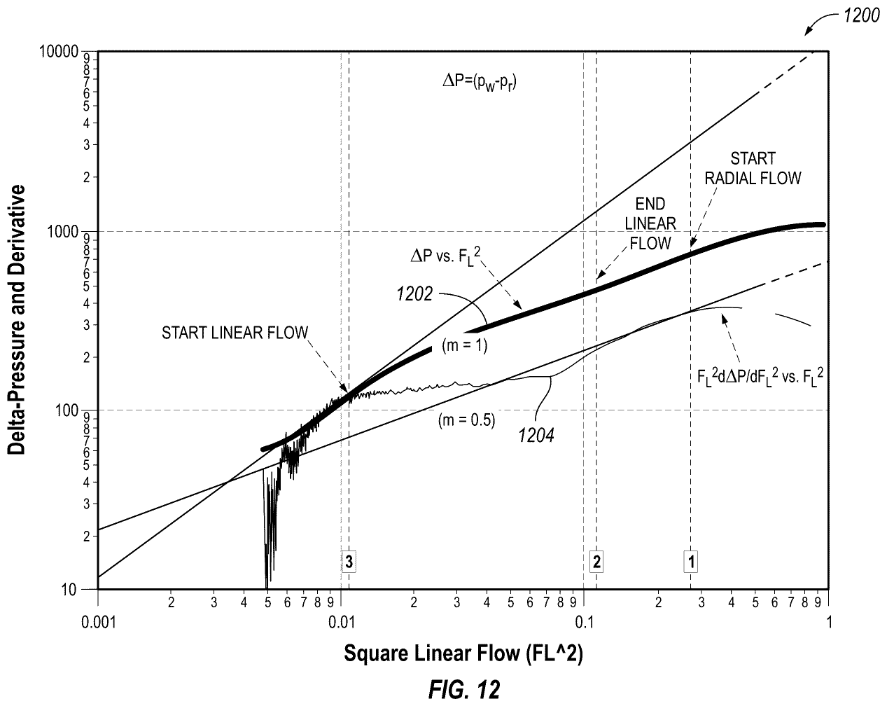

Embodiments of the disclosure may identify the transient flow regime prior to performing an after-closure analysis (ACA) following the closure of the fracture. A Talley-Nolte After-Closure Analysis (ACA) flow regime plot may be used for identifying reservoir linear and radial flow periods. FIG. 12 depicts an example Talley-Nolte After-Closure Analysis (ACA) flow regime plot 1200 from a pressure dependent leak-off (PDL) test in accordance with an embodiment of the disclosure. The plot 1200 depicts delta-pressure and derivative on the y-axis and square linear flow (FL²) on the x-axis. As shown in FIG. 12, the heavy solid (blue) line 1202 is the observed bottom hole pressure (Pw) during falloff minus the initial reservoir pressure (Pi). The slope of the semi-log derivative of the pressure difference function (line 1204) is ½ during the linear-flow period and 1.0 (unit slope) during the pseudo-radial flow period.

As the two flow regimes are identifiable from the example plot shown in FIG. 12, the linear flow plot may be used to determine closure time, spurt loss and fracture length. The radial-flow plot allows transmissibility to be calculated using a technique similar to Horner analysis.

### Non-Ideal Fracture Geometries

As discussed supra, the original theoretical derivation of the pressure versus dimensionless time (G-function) analysis for fracture leak-off to closure is applicable in an idealized isotropic, linear-elastic, homogeneous media with fractures of constant height and compliance. Deviations from any of these assumptions can result in non-linear pressure-time declines. Beyond the standardized non-ideal pressure behavior observed due to pressure dependent leak-off (PDL), Fracture Tip Extension, etc., which are broadly classified as being related to near wellbore or to the reservoir and fracture geometry embodiments of the disclosure recognize other aspects in the operational theater that may affect the analysis. For example, the quality of hydraulic communication between the fracture and the perforations in the wellbore may be an important factor, as poor connectivity can act as a bottom hole choke that masks true pressure responses. Such a phenomenon may manifest in an injection test as poor water hammer effects that result in incorrect instantaneous shut-in pressure (ISIP) picks. Another wellbore-related anomaly is phase segregation and gas entry during the fall-off period while the well is sitting undisturbed. In such instances, a rising gas bubble could exert extra pressure at the perforations leading to higher leak-off. This may not affect fracture response but if not properly understood could appear like a pressure dependent leak-off (PDL) signature.

Embodiments of the disclosure further recognize, from a reservoir or fracture mechanics standpoint, several geomechanical factors unrelated to the fracture created during the injection test that could develop non-linear pressure decline. For example, numerous documented cases from observations of direct fracture diagnostics, mine-backs, and core-throughs show fractures in multiple parallel planes, in multiple directions, and in a “T-shaped” fashion with both horizontal and vertical components. In such instances, it is highly unrealistic to expect ideal planar bi-wing propagation of induced hydraulic fractures. Instead, it is likely that non-ideal configurations may be obtained, including sub-longitudinal coalescences of discrete cracks along the wellbore and hydraulic fracture complexity due to the severe interaction with near wellbore stresses (possibly altered by drilling, pre-existing natural fractures, joints, and generic planes of weakness). The deformation of the rock mass around the primary fracture, increases in local pore pressure, and changes in closure pressure magnitude may all increase the leak-off rate and create an accelerated leak-off signature.

Moreover, the hydraulic fractures that are first originated longitudinally from the top/bottom of the wellbore may then be subject to realignment (with inherent tortuosity) towards the maximum principal in-situ stress. Delayed leak-off may thus be strongly impacted by longitudinal and transverse multiple fractures along the well or remote from the well, or by bulk and pore volume compressibility behaviors.

Additionally, embodiments of the disclosure recognize that “fracture complexity” is closely related to tectonic setting (field stress regime) and burial history of the basin in which the rock resides. As such, favorable complexity is encountered in a normal stress regime area while problematic complexity is seen in a strike slip stress regime environment. Tectonic setting is interpreted as the first order of control on NFP (net fracture pressure) complexity since increasingly complex tectonic and burial histories elevate stresses and create tectonic fractures that promote increasingly complicated interactions between induced hydraulic fractures and intrinsic rock fractures.

The process 100 further includes performing machine learning (ML) processing (block 112) on the various data discussed supra. The machine learning model of the process 100 may determine 3D minimum horizontal stress as a continuous 3D property from a few scattered wells where formation integrity test, leak-off test and fracture closure pressure has been measured. The machine learning model may be provided other 3D petrophysical, geomechanical and fracture density index properties that have been modeled before to learn from in a supervised regression machine learning problem. Once a prediction is made, the 3D minimum horizontal stress may be outputted by the ML model. This output may be used to predict fracking sweet spot for future well placement and in the drilling of wells and hydraulic fracturing stimulation.

The training data for the machine learning model may include observation points such as fracture integrity test data, leak-off test data, and fracture closure pressure test data as discussed herein, and the 3D petrophysical, geomechanical and fracture density index properties also discussed herein, to learn from in a supervised regression machine learning task.

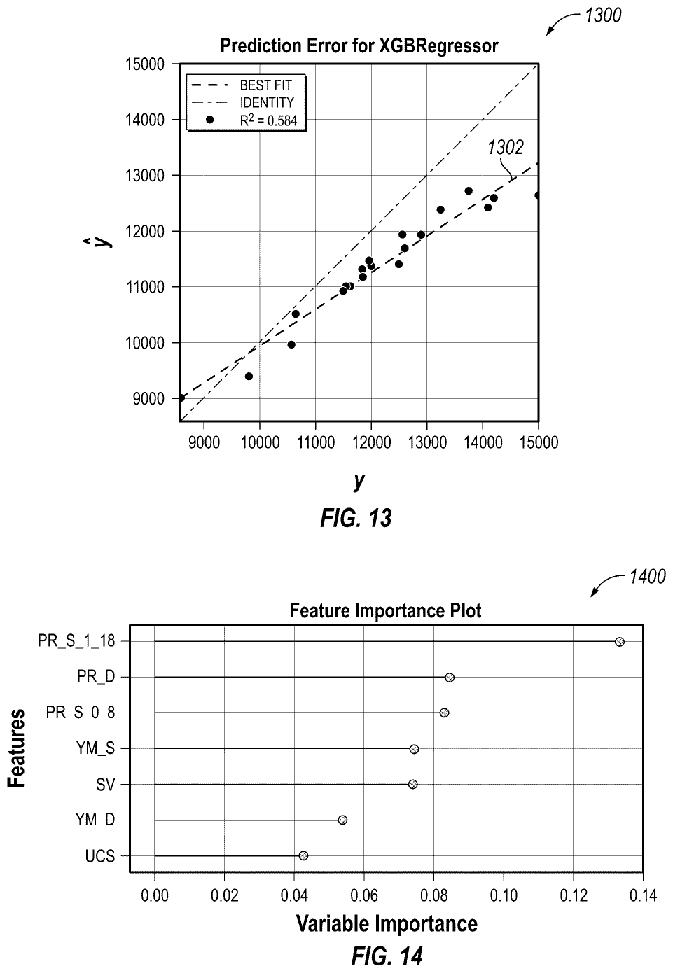

In some embodiments, the training algorithm for the machine learning model may include extreme gradient boosting (xgboost), which constructs gradient boosted trees that will be executed in sequence to make the prediction. Each tree may be constructed to predict the residuals from the previous trees within the constraints of learning rate, and other model parameters like tree depth and count. By way of example, FIG. 13 depicts a plot 1300 of the prediction accuracy for a machine learning model trained using extreme gradient boosting in accordance with an embodiment of the disclosure. As shown in the plot 1300 and the fitted line 1302, the training with extreme gradient boosting was able to produce a prediction accuracy R2 of 0.584.

The training algorithm for the machine learning model may determine the feature importance for the final predictions. By way of example, FIG. 14 is a line chart 1400 of the seven most important features in predicting minimum horizontal stress. In such embodiments, the extreme gradient boosting training algorithm may sort features by how often they appear in trees, such that a feature is given more importance if it appears more often. As shown in FIG. 14, these features include Poisson's Ratio Static converted with a factor of PR_D of 1.18 (PR_S_1_18), Poisson's Ratio Static converted with a factor of PR_D of 0.8 (PR_S_0_8), Young's Modulus Static (YM_S), Vertical Stress (Sv), Young's Modulus Dynamic (YM_D), and Unconfined Compressive Strength (UCS).

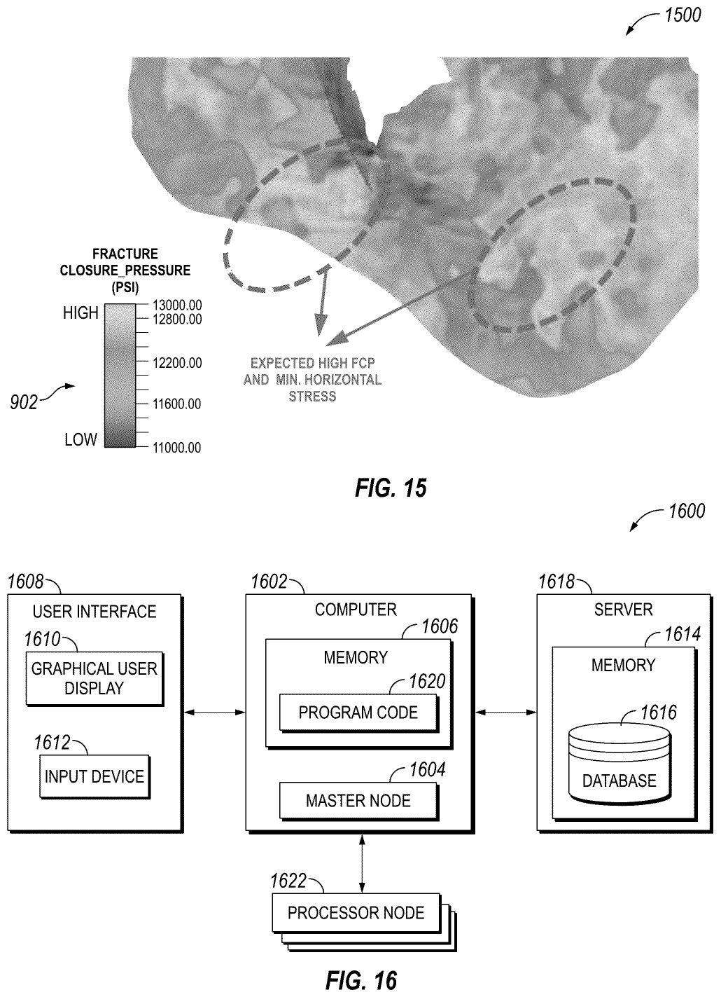

After training the machine learning model, the minimum horizontal stress may be determined (block 114) based on the combination of the petrophysical, geomechanical and fracture density index properties as discussed in the disclosure. FIG. 15 depicts a 3D minimum horizontal stress magnitude within a 3D grid model 1500 in accordance with an embodiment of the disclosure. As shown in FIG. 15, the horizontal stress magnitude is shown in different colors indicated by the color legend 1502, and the areas having the largest and smallest minimum horizontal stress magnitudes are identified. The highlighted areas indicate those areas with an expected large fracture closure pressure (FCP) and bottom hole treating pressure (BHTP), and thus a large minimum (min.) horizontal stress.

The process 100 may additionally include determining a sweet spot for a hydraulic fracturing stimulation operation based on the 3D minimum horizontal stress. Additionally, the process 100 may include performing a hydraulic fracturing stimulation operation based on the determined sweet spot or controlling a hydraulic fracturing stimulation operation based on the determined sweet spot.

FIG. 16 depicts a data processing system 1600 that includes a computer 1602 having a master node processor 1604 and memory 1606 coupled to the processor 1604 to store operating instructions, control information and database records therein in accordance with an embodiment of the disclosure. The data processing system 1600 may be a multicore processor with nodes such as those from Intel Corporation or Advanced Micro Devices (AMD), or an HPC Linux cluster computer. The data processing system 1600 may also be a mainframe computer of any conventional type of suitable processing capacity such as those available from International Business Machines (IBM) of Armonk, N.Y., or other source. The data processing system 1600 may in cases also be a computer of any conventional type of suitable processing capacity, such as a personal computer, laptop computer, or any other suitable processing apparatus. It should thus be understood that a number of commercially available data processing systems and types of computers may be used for this purpose.

The computer 1602 is accessible to operators or users through user interface 1608 and are available for displaying output data or records of processing results obtained according to the present disclosure with an output graphic user display 1610. The output display 1610 includes components such as a printer and an output display screen capable of providing printed output information or visible displays in the form of graphs, data sheets, graphical images, data plots and the like as output records or images.

The user interface 1608 of computer 1602 also includes a suitable user input device or input/output control unit 1612 to provide a user access to control or access information and database records and operate the computer 1602. Data processing system 1600 further includes a database of data stored in computer memory, which may be internal memory 1606, or an external, networked, or non-networked memory as indicated at 1614 in an associated database 1616 in a server 1618.

The data processing system 1600 includes executable code 1620 stored in non-transitory memory 224 of the computer 1602. The executable code 1620 according to the present disclosure is in the form of computer operable instructions causing the data processor 1604 to determine petrophysical properties, determine geomechanical properties, determine natural fracture properties, and control and receive results of formation testing. Moreover, the computer operable instructions of the executable code 1620 may execute and train a machine learning model according to the techniques described herein, and may determine minimum horizontal stress using the machine learning model.

It should be noted that executable code 1620 may be in the form of microcode, programs, routines, or symbolic computer operable languages capable of providing a specific set of ordered operations controlling the functioning of the data processing system 1600 and direct its operation. The instructions of executable code 1620 may be stored in memory 1606 of the data processing system 1600, or on computer diskette, magnetic tape, conventional hard disk drive, electronic read-only memory, optical storage device, or other appropriate data storage device having a non-transitory computer readable storage medium stored thereon. Executable code 1620 may also be contained on a data storage device such as server 1618 as a non-transitory computer readable storage medium, as shown.

The data processing system 1600 may be include a single CPU, or a computer cluster as shown in FIG. 16, including computer memory and other hardware to make it possible to manipulate data and obtain output data from input data. A cluster is a collection of computers, referred to as nodes, connected via a network. A cluster may have one or two head nodes or master nodes 1604 used to synchronize the activities of the other nodes, referred to as processing nodes 1622. The processing nodes 1622 each execute the same computer program and work independently on different segments of the grid which represents the reservoir.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for determining three-dimensional minimum horizontal stress in a naturally fractured hydrocarbon reservoir, the method comprising:
obtaining reservoir parameters representing properties of the subsurface reservoir for processing in a data processing system;
forming a discrete fracture network by processing the obtained reservoir parameters in the data processing system to identify the presence and extent of natural fractures at locations in the subsurface hydrocarbon reservoir;
determining, by the data processing system and using the discrete fracture network, a fracture density index (FDI), wherein determining, using the discrete fracture network, a fracture density index (FDI) comprises generating a raster map from the discrete fracture network, the raster map representing a fracture density per area;
receiving, at the data processing system, first formation testing data produced by one or more formation tests, the formation tests comprising a leak-off test (LOT), a formation integrity test (FIT), and an extended leak-off test (XLOT);
receiving, at the data processing system, second formation testing data produced by a diagnostic fracture injection test (DFIT); and
determining, by the data processing system, three-dimensional (3D) minimum horizontal stress horizontal stress in the naturally fractured hydrocarbon reservoir using a machine learning model receiving, as input, the reservoir parameters, the fracture density index, the first formation testing data, and the second first formation testing data.

2. The method of claim 1, wherein the reservoir parameters comprise seismic attributes from seismic surveys of the subsurface geological structure.

3. The method of claim 1, wherein the properties comprise geomechanical properties comprising Young's modulus, Poisson's ratio, unconfined compressive strength, of any combination thereof.

4. The method of claim 1, wherein the properties comprise geomechanical properties comprising bulk density, vertical stress, pore pressure, or any combination thereof.

5. The method of claim 1, comprising determining a sweet spot for hydraulic fracturing stimulation based on the 3D minimum horizontal stress.

6. The method of claim 5, comprising performing a hydraulic fracturing stimulation operation based on the determined sweet spot.

7. The method of claim 1, comprising performing the diagnostic fracture injection test (DFIT).

8. The method of claim 1, wherein the machine learning model is trained using extreme gradient boosting.

9. A non-transitory computer-readable storage medium having executable code stored thereon for determining three-dimensional minimum horizontal stress in a naturally fractured hydrocarbon reservoir, the executable code comprising a set of instructions that causes a processor to perform operations comprising:
obtaining reservoir parameters representing properties of the subsurface reservoir;
forming a discrete fracture network by processing the obtained reservoir parameters to identify the presence and extent of natural fractures at locations in the subsurface hydrocarbon reservoir;
determining, using the discrete fracture network, a fracture density index (FDI), wherein determining, using the discrete fracture network, a fracture density index (FDI) comprises generating a raster map from the discrete fracture network, the raster map representing a fracture density per area;
receiving first formation testing data produced by one or more formation tests, the formation tests comprising a leak-off test (LOT), a formation integrity test (FIT), and an extended leak-off test (XLOT);
receiving second formation testing data produced by a diagnostic fracture injection test (DFIT); and
determining three-dimensional (3D) minimum horizontal stress horizontal stress in the naturally fractured hydrocarbon reservoir using a machine learning model receiving, as input, the reservoir parameters, the fracture density index, the first formation testing data, and the second first formation testing data.

10. The non-transitory computer-readable storage medium of claim 9, wherein the reservoir parameters comprise seismic attributes from seismic surveys of the subsurface geological structure.

11. The non-transitory computer-readable storage medium of claim 9, wherein the properties comprise geomechanical properties comprising Young's modulus, Poisson's ratio, unconfined compressive strength, of any combination thereof.

12. The non-transitory computer-readable storage medium of claim 9, wherein the properties comprise geomechanical properties comprising bulk density, vertical stress, pore pressure, or any combination thereof.

13. The non-transitory computer-readable storage medium of claim 9, comprising determining a sweet spot for hydraulic fracturing stimulation based on the 3D minimum horizontal stress.

14. The non-transitory computer-readable storage medium of claim 12, comprising controlling a hydraulic fracturing stimulation operation based on the determined sweet spot.

15. A system for determining three-dimensional minimum horizontal stress in a naturally fractured hydrocarbon reservoir, comprising:
a processor;
a non-transitory computer-readable memory accessible by the processor and having executable code stored thereon, the executable code comprising a set of instructions that causes a processor to perform operations comprising
obtaining reservoir parameters representing properties of the subsurface reservoir;
forming a discrete fracture network by processing the obtained reservoir parameters to identify the presence and extent of natural fractures at locations in the subsurface hydrocarbon reservoir;
determining, using the discrete fracture network, a fracture density index (FDI), wherein determining, using the discrete fracture network, a fracture density index (FDI) comprises generating a raster map from the discrete fracture network, the raster map representing a fracture density per area;
receiving first formation testing data produced by one or more formation tests, the formation tests comprising a leak-off test (LOT), a formation integrity test (FIT), and an extended leak-off test (XLOT);
receiving second formation testing data produced by a diagnostic fracture injection test (DFIT); and
determining three-dimensional (3D) minimum horizontal stress horizontal stress in the naturally fractured hydrocarbon reservoir using a machine learning model receiving, as input, the reservoir parameters, the fracture density index, the first formation testing data, and the second first formation testing data.

16. The system of claim 14, wherein the reservoir parameters comprise seismic attributes from seismic surveys of the subsurface geological structure.

17. The system of claim 14, wherein the properties comprise geomechanical properties comprising Young's modulus, Poisson's ratio, unconfined compressive strength, of any combination thereof.

18. The system of claim 14, wherein the properties comprise geomechanical properties comprising bulk density, vertical stress, pore pressure, or any combination thereof.

19. The system of claim 14, comprising determining a sweet spot for hydraulic fracturing stimulation based on the 3D minimum horizontal stress.

20. The system of claim 19, comprising controlling a hydraulic fracturing stimulation operation based on the determined sweet spot.
